(19) United States
(12) Patent Application Publication
(10) Pub. No.: US 2002/0021850 A1
(43) Pub. Date: Feb. 21, 2002

(54) On aluminum bearings and its alloys, for use in hermetic compressors

(76) Inventor: Sergio Bertachini, Sao Carlos (BR)

Correspondence Address: JOHN F. HOFFMAN, BAKER & DANIELS, 111 East Wayne Street, Suite 800, Fort Wayne, IN, 46802, US

(21) Appl. No.: 09/774,855

(22) Filed: Jan. 31, 2001

(30) Foreign Application Priority Data
Aug. 18, 2000 (BR) PI 0003902-0

(51) Int. Cl. F16C 33/02

(52) U.S. Cl. 384/276

(57) ABSTRACT

A process for preventing the eventual wear of a bearing for a compressor, including: providing a bearing having a sliding surface and made of aluminum or an aluminum alloy; treating the bearing sliding surface with an application of zinc phosphate; and forming a layer of phosphate on the bearing sliding surface, whereby a solid lubricant is provided on the bearing sliding surface. Also, a bearing for a compressor, the bearing including a material selected from a group consisting of aluminum and an aluminum alloy, the bearing having a sliding surface provided with a layer of zinc phosphate thereon, the zinc phosphate layer providing a solid lubricant on the sliding surface, whereby the start of eventual wear of the bearing is prevented.

### BACKGROUND OF THE INVENTION

As is well known, a bearing is a machine element that normally goes between two rigid parts in relative movement, and normally has a lubricant fluid inserted between the referred rigid parts. The purpose of a bearing is to replace the dry friction between rigid parts with viscous friction in the lubricant fluid, thus reducing the running temperature, the friction itself, and the early wear of the surfaces of the rigid parts which would otherwise be in contact.

It is equally well known that a hermetic compressor is equipped with radial and axial bearings located between its rotating crankshaft and the fixed surfaces supporting the crankshaft. Thus a relative velocity exists between the crankshaft and these surfaces. On the other hand, there is normally lubricant oil inside the compressor and between the crankshaft and its supporting surfaces, causing them to act as hydrodynamic bearings. In addition to the abovementioned bearings, in reciprocating piston compressors, there are also bearings at both ends of the compressor connecting rod(s).

The above-mentioned bearings are normally made from cast iron, steel or aluminum alloys, and one of the last manufacturing operations therefor is a surface treatment known as “phosphatization.” Phosphatization consists of a chemical or electrochemical process from which a small thickness layer and fine crystallization over metallic surfaces are obtained, through immersion or spraying, and from phosphoric acid solutions. The light gray to dark gray metallic phosphate layers adhere strongly into the metallic surface. This happens as a result of a chemical reaction with the base material and they have many pores and capillaries. This property provides the phosphate coat with an excellent absorption capacity for oils, waxes, pigments and paints. That is why such coatings impose themselves as a basis for adherence and anti-rust protection to paints.

Phosphatization is also used for the reduction of the friction forces in wiredrawing deformation and sliding processes, which results in an improvement in the quality of the wiredrawn part (wire or tube) surface. Further, the respective tool will also last longer and the wiredrawing speed will be faster.

It is also well known a reduction in friction in bearings made from steel and cast iron alloys may be achieved after the introduction, to the bearing, of manganese phosphate. This phosphate even enables oil retention, despite its action as a solid lubricant on the contacting metallic parts.

Concerning the quality of the metallic phosphate coatings adhered to the surface of the treated parts, it depends, greatly, on the activation of the mentioned surface, before the phosphatization, as well as on the composition of the phosphatizing solution, and also on the very working conditions. All this shows that an adequate pretreatment of the surface to be treated is important to obtaining a good adherence of the metallic phosphate coating.

Also, referring to what it is already known from the previous technique, it is worth mentioning that zinc phosphate coatings are of very fine crystallization, and have been used as a pre-painting on steel and aluminum parts. But, so far, they are not yet known or applied to aluminum or aluminum alloy bearings.

### SUMMARY OF THE INVENTION

The present invention provides a process for preventing the eventual wear of a bearing for a compressor. The inventive process includes providing a bearing having a sliding surface and made of aluminum or an aluminum alloy, treating the bearing sliding surface with an application of zinc phosphate, and forming a layer of phosphate on the bearing sliding surface, whereby a solid lubricant is provided on the bearing sliding surface.

The present invention also provides a bearing for a compressor which is of an aluminum or aluminum alloy material, and has a sliding surface provided with a layer of zinc phosphate thereon. The zinc phosphate layer provides a solid lubricant on the bearing sliding surface, whereby the start of eventual wear of the bearing is prevented.

The present invention also provides an improvement on bearings of aluminum and their alloys, for use in hermetic compressors. The improvement includes the application of zinc phosphate as a surface treatment on a bearing which is aluminum or an alloy thereof, for use in hermetic refrigeration compressors. The inventive surface treatment produces a surface layer of phosphate that acts as a solid lubricant on the sliding metallic surfaces of the bearings, thus preventing an eventual wear to initiate.

### DETAILED DESCRIPTION OF THE INVENTION

In face of the above circumstances, improvements have been made on aluminum bearings and their alloys, used in hermetic compressors, which is the object of the present invention. Such improvements refer exactly to the application of a zinc phosphate coat on bearings produced from aluminum and aluminum alloys to soften their surface contact with metallic parts of the equipment they are being used in, particularly hermetic compressors and, as a result, increasing their useful life significantly.

The present invention provides a process for preventing the eventual wear of a bearing for a compressor, including: providing a bearing having a sliding surface and made of aluminum or an aluminum alloy; treating the bearing sliding surface with an application of zinc phosphate; and forming a layer of phosphate on the bearing sliding surface, whereby a solid lubricant is provided on the bearing sliding surface.

The present invention also provides a bearing for a compressor, the bearing including a material selected from a group consisting of aluminum and an aluminum alloy, and having a sliding surface provided with a layer of zinc phosphate, said zinc phosphate layer providing a solid lubricant on the sliding surface, whereby the start of eventual wear of the bearing is prevented.

Taking as a reference a hermetic compressor having bearings produced from aluminum alloys, the oil that enters the bearings produces a natural lubricant film on the sliding surfaces (moving parts of compressor), preventing the contact of the parts. However, every time the hermetic compressor starts it is always a critical moment, because the oil has not yet been introduced by the pump and is not available in sufficient amount to prevent the metal/metal contact of the bearing parts. It is just there that the object of the present invention lies and justifies itself, for, once the mentioned bearings have been submitted to the application surface treatment of the zinc phosphate, the phosphate coat now obtained will minimize the referred contact, thus increasing the bearings useful life.

With the phosphatization of aluminum bearings, in the manner as suggested by the present invention, a buildup or layer of small sized zinc phosphate crystals on the bearing surfaces occurs. These crystals are friable and, therefore, just after the compressor starts, they get misshaped and act as a solid lubricant, thus preventing an eventual wear to initiate on the sliding surfaces of the bearings, and thus assuring their long life and good performance.

What is claimed is:

1. A process for preventing the eventual wear of a bearing for a compressor, comprising:
providing a bearing having a sliding surface and made of aluminum or an aluminum alloy;
treating the bearing sliding surface with an application of zinc phosphate; and
forming a layer of phosphate on the bearing sliding surface, whereby a solid lubricant is provided on the bearing sliding surface.

2. The process of claim 1, wherein said treating step comprises phosphatizing the bearing sliding surface.

3. A bearing for a compressor, said bearing comprising a material selected from a group consisting of aluminum and an aluminum alloy, said bearing having a sliding surface provided with a layer of zinc phosphate thereon, said zinc phosphate layer providing a solid lubricant on said sliding surface, whereby the start of eventual wear of said bearing is prevented.

4. The bearing of claim 3, wherein said sliding surface has been phosphatized.

5. An improvement on bearings of aluminum and their alloys, for use in hermetic compressors, comprising the application of zinc phosphate as a surface treatment on a bearing selected from a group consisting of aluminum and its alloys, for use in hermetic refrigeration compressors, to produce a surface layer of phosphate that acts as a solid lubricant on the sliding metallic surfaces of the bearings, thus preventing an eventual wear to initiate.
